(19) United States
(12) Patent Application Publication
(10) Pub. No.: US 2011/0242037 A1
(43) Pub. Date: Oct. 6, 2011

(54) METHOD FOR CONTROLLING A SELECTED OBJECT DISPLAYED ON A SCREEN

(75) Inventor: Alexander Gruber, Berlin (DE)

(73) Assignee: Zero1.tv GmbH, Berlin (DE)

(21) Appl. No.: 13/159,099

(22) Filed: Jun. 13, 2011

(30) Foreign Application Priority Data
Jan. 26, 2009 (DE) DE200910006082
Jan. 26, 2010 (DE) PCT/DE2010/000074

(51) Int. Cl. G06F 3/041; G09G 5/00

(52) U.S. Cl. 345/173; 345/156

(57) ABSTRACT

A system and method is described for controlling a selected input object displayed on a screen using at least one object. The three-dimensional position of the input object relative to a plane is monitored. The position of the input object parallel to the plane defines coordinates for the position of the selected object on the screen, and the display of the selected object on the screen changes in accordance with the position of the input object in a direction perpendicular to the plane.

### CROSS-REFERENCE TO RELATED APPLICATIONS

This application is a continuation application of International Application No. PCT/DE2010/000074 filed Jan. 26, 2010, which claims priority to German Patent Application No. DE200910006083, which was filed on Jan. 26, 2009; and German Patent Application No. DE200910006082, which was filed on Jan. 26, 2009, all of which are hereby incorporated by reference in their entirety.

### BACKGROUND

A cursor-type indicator or other selected objects have become generally established in the operation of personal computers and other electronic devices that use a monitor or other electronic display such as a television set as their output medium. A cursor is an indicator or selected object that is typically displayed on a screen. It can take various forms. The most common application of the cursor is in the shape of an arrow. Other images such as a cross, a stylized hand or other graphical elements are possible.

A cursor is an indicator or selected object that can display two-dimensional movements of input devices on a screen. Typical input devices include the mouse, touch pad, track ball, track point, graphic tablet and the like. A cursor is suitable for displaying the inputs from these input devices since traditional input devices can only provide a position in a two-dimensional space.

However, current developments in the field of input devices have resulted in the emergence of a class of input devices over the past few years that are capable of measuring three-dimensional input values and transmitting them, for example, to a personal computer or another electronic device that processes three-dimensional input values. This new class of so-called three-dimensional input devices includes touch-sensitive input boxes, pressure-sensitive touch pads/touch screens, camera-based systems for detecting objects in a three-dimensional space.

The current development of output devices has also been showing a strong tendency towards a further spread of devices that can display three-dimensional images. Researchers and developers at manufacturers of home electronic devices have much advanced this topic in recent years. It is possible to use special technologies to display images and objects on a two-dimensional screen such that they appear to be three-dimensional. Optical aids such as special 3D glasses are used to achieve this.

The consumer has the impression of spatial depth. As described, prior art cursor-type screen objects are restricted to a two-dimensional display.

An intermediate form between classic two-dimensional and three-dimensional display is the so-called 2.5D (two-and-a-half-dimensional) display. Images and objects are displayed in three-dimensional form on a two-dimensional screen. For example, a cube can be displayed as a three-dimensional shape on a two-dimensional screen.

### BRIEF DESCRIPTION OF THE DRAWINGS

Examples of a system that displays input from a three-dimensional input device on a two-dimensional display. The examples and figures are illustrative rather than limiting.

FIG. 1 shows a view of the position of an input object parallel to a plane and coordinates for the position of a corresponding selected object on a screen.

FIG. 2 shows a view of a selected object displayed on a screen.

FIG. 3 shows a first view of a selected object on a screen that changes size depending on the position of the input object perpendicular to the plane.

FIG. 4 shows a second view of the selected object on the screen that changes size depending on the position of the input object perpendicular to the plane.

FIG. 5 shows a first view of a selected object on a screen that changes function depending on the position of the input object perpendicular to the plane.

FIG. 6 shows a second view of a selected object on a screen that changes function depending on the position of the input object perpendicular to the plane.

### DETAILED DESCRIPTION

Described below is a type of indicator or selected object that is capable of displaying commands from a three-dimensional input device on a screen or other visual output medium that supports three-dimensional display, in particular, on a two-dimensional screen. The display of the selected object on the screen changes depending on the position of an input object that manipulates the input device relative to a pre-selected plane.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

In one embodiment, three-dimensional signals that indicate the position of an input object in space are processed and translated to the display of a selected object on a screen. It is important to point out that all display modes in 2D, 2.5D, and 3D are supported.

Inputs can be made using any input device that is capable of detecting a unique three-dimensional position of an input object, which can also be the input device itself, relative to a plane and of transmitting this position, for example, to a personal computer or to another electronic processing device. The monitored and detected position of the input object is preferably transmitted in the form of X, Y, and Z values, wherein the X and Y values preferably indicate the position of the input object parallel to the plane and the Z value indicates the position of the input object perpendicular to the plane.

Examples of an input device include a device that allows the detection of a three-dimensional position of an input object by a field of light-emitting diodes called an array, a pressure-sensitive touch pad, preferably with two or more pressure levels; an optical system with camera support; and any system that is capable of identifying the three-dimensional position of an object used as an input object based on an X, Y, and Z value.

The display of a selected object on the screen that changes depending on the distance of the input object from the plane may include a change in the display size of the selected object. It is preferred that the selected object is displayed the bigger on the screen the farther the input object is away from the plane.

In an embodiment of the invention, different functionalities or functions are assigned to the selected object depending on the distance of the input object perpendicular to the plane or the position of the input object perpendicular to the plane, respectively. For example, it is conceivable that, during a running video replay, a reduction of the distance of the input object to the plane is assigned to a fast forward function and an increase in distance of the input object to the plane is assigned to a rewind function. It is also conceivable that, in a running text processing program, for example, a position change of the input object perpendicular to the plane resulting in a change of the Z value from z₁ to z₂ changes the function of the selected object from Paste to Copy.

In certain embodiments contact of the plane with the input object and/or a distance of the input object to the plane is less than a predefined distance and/or an approach of the input object to the plane at greater than a predefined speed triggers a function of the selected object.

In an embodiment of the invention, the input object is an input device that detects its three-dimensional position relative to a plane.

In another embodiment of the invention, the input object is at least one finger of at least one hand of the user.

Monitoring the three-dimensional position of the input object relative to a plane preferably provides X, Y, and Z values, wherein the X and Y values indicate the position of the input object parallel to the plane and the Z value indicates the position of the input object in a direction perpendicular to the plane.

The display of the selected object on the screen may, for example, include a semi-transparent and/or circular display.

Two or more input objects can be provided, and their three-dimensional positions relative to the plane be monitored, wherein a function of the selected object is triggered in at least one predefined constellation of the positions of the input objects.

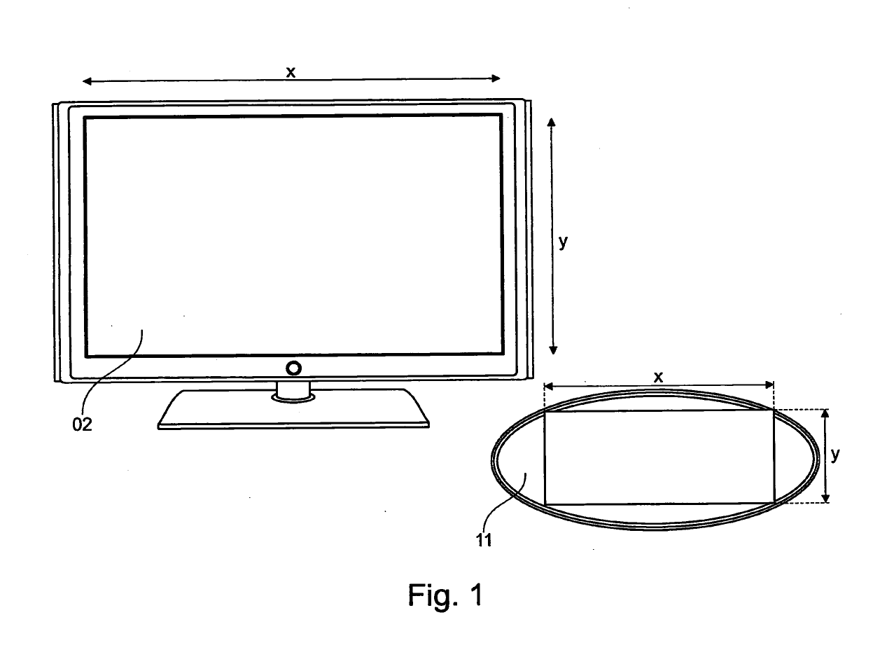

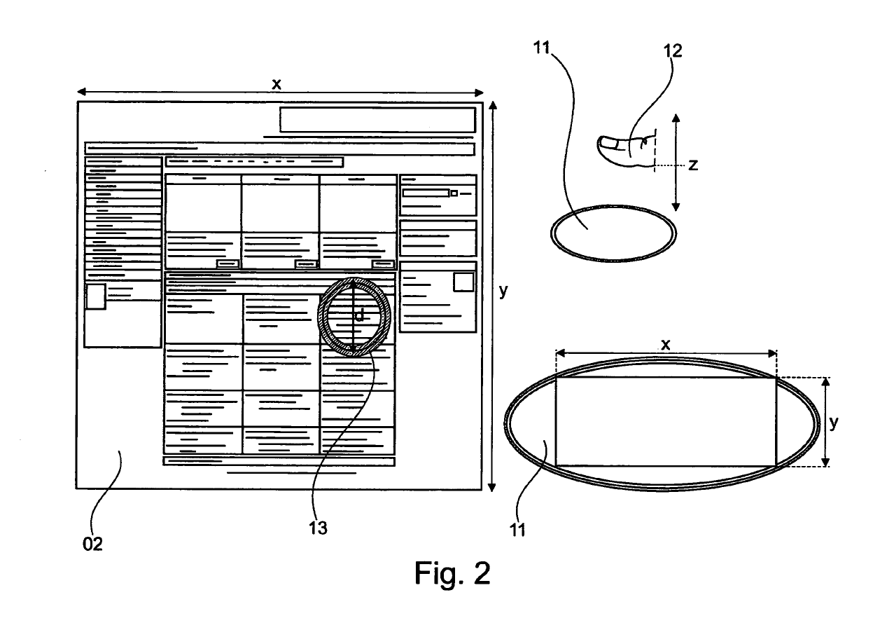

FIGS. 1 and 2 show a top view of a plane 11, relative to which the three-dimensional position of an input object 12 shown in FIGS. 2 to 6, e.g. a user's finger 12, is monitored. The plane 11 can be a part of a three-dimensional input device for controlling a selected object 13 displayed on a screen 02 (FIGS. 2 to 6). It is preferred that the input device can simultaneously detect the position of one or several objects generally designated as input objects 12, e.g. a finger 12, in a three-dimensional space using light-emitting diodes. It is preferred that the input device is operated with one or several fingers 12. The input device delivers an X, Y (FIG. 1), and a Z value (FIGS. 2 to 6) when detecting the three-dimensional position of an input object 12 relative to the plane 11.

The input device indicates the position of the input object 12 parallel to the plane 11 using an X and a Y value (FIG. 1). It is apparent from FIG. 1 that the X values delivered by an input device to a processing device connected to the screen 02 and generating the display are used for positioning a selected object 13 on the width axis of the screen 02, also called X axis. The Y values are used for positioning the selected object 13 on the height axis, also called Y axis.

FIGS. 2 to 6 each show a lateral view of the plane 11 from FIG. 1. Input objects 12 are detected that are located above the surface of the plane 11. The input device indicates the distance of an input object 12 to plane 11 as the Z value.

While the X and Y values of the position of the input object 12 parallel to the plane 11 set the coordinates of the position of the selected object 13 on the screen 02, which are also given in X and Y values, the display of the selected object 13 on the screen 02 is intended to change depending on the position of the input object perpendicular to the plane 11 that is given as the Z value.

FIGS. 2 to 4 show the selected object 13. It may be circular, for example, and preferably half- or semi-transparent. The selected object 13 may have other geometrical shapes than a circle. The selected object 13 may also consist of any kind of monochrome or multi-colored images. The position of the selected object 13 on the screen 02 is determined by the X and Y values. The Z value, on the other hand, influences the display of the selected object 13 on the screen 02.

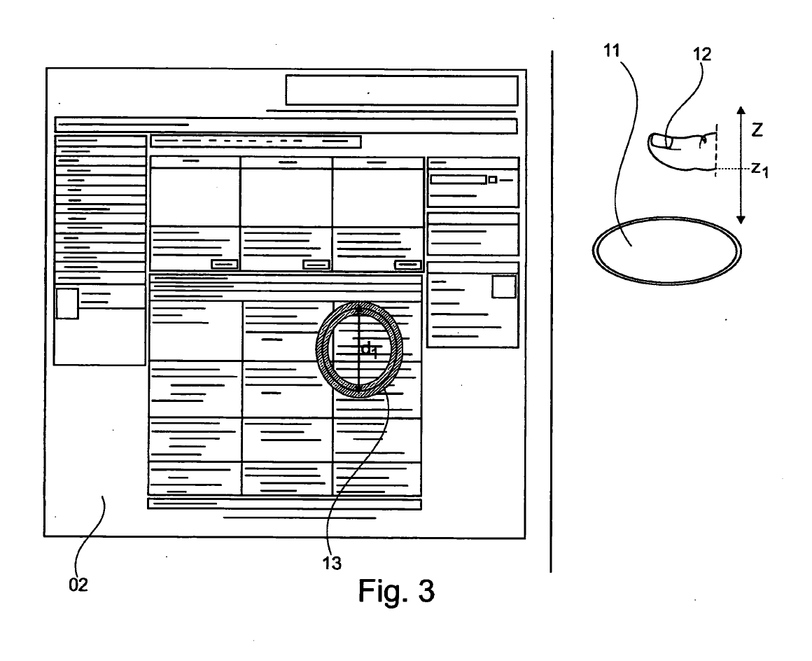

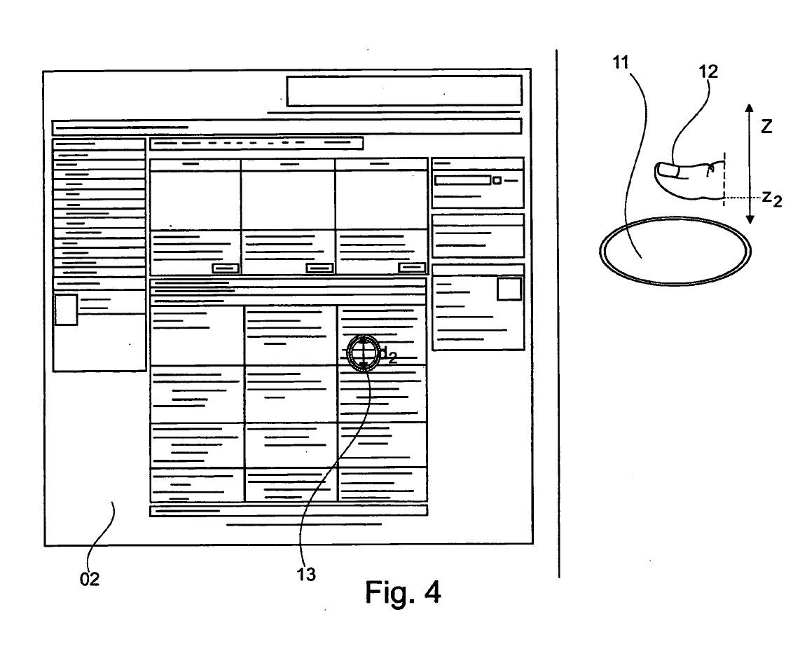

It is, for example, conceivable that the Z value influences the display of the selected object 13 on the screen 02 as shown diagrammatically in FIGS. 3 and 4 such that the display size of the selected object 13 given as diameter d changes depending on the distance of the input object 12 from the plane 11 given by the Z value. There can either be a linear or a logarithmic connection between the position of the input object 12 perpendicular to the plane 11 that sets the Z value and the diameter d. Any other kind of mathematical links between Z and d are possible.

It is preferred that a decrease of the Z value results in a decrease of the diameter d. But there are applications where it is desirable that a decrease of the Z value results in a greater diameter d.

FIGS. 3 and 4 show an example of a size change of the selected object 13 when the position of the input object 12 perpendicular to the plane 11 that determines the Z value changes.

FIG. 3 shows the example of a three-dimensional input device that includes the plane 11 and allows monitoring and detection of the three-dimensional position of an input object 12 using a field of light-emitting diodes also called an array for determining the Z value. In this case, the Z value is determined based on the distance of the input object 12, here a finger 12, to the surface of the plane 11. The Z value resulting from the position of the finger 12 shown is z₁. For the selected object, this results in a diameter d₁ based on the said algorithms.

In comparison to FIG. 3, FIG. 4 shows how the display of the selected object 13 changes due to a change of the Z value resulting from a change of the position of the finger 12 that is used as the input object 12 perpendicular to the plane 11. The determined Z value z₂ to which the relationship z₂<z₁ applies results in a selected object 13 having a diameter d₂, wherein d₂<d₁. The selected object 13 thus changes its size as a function of the Z value or depending on the position of the input object 12 perpendicular to the plane 11, respectively.

Alternatively, or in addition, a change of the Z value may result in other changes of the selected object 13. Other attributes of the selected object 13 can be varied in addition to, or in lieu of, a change in size of the screen object when the Z value changes. For example, a change of the Z value may result in a color change of the selected object 13. A change of the Z value may also result in any change in shape of the selected object 13. A change of the Z value may further result in a change of images that pop up.

The changes shown in FIGS. 3 and 4 refer to a display on a two-dimensional output medium.

As described at the outset, there are also two-and-a-half- and three-dimensional output options. The user is given the impression that the objects on the screen have an optical depth. This depth display is simulated in a 2.5D display. A 3D display provides a genuine 3D effect using optical aids (preferably a pair of 3D glasses).

In such a display, the selected object 13 can advantageously be represented in such a way that the user gets the impression that the object is moving in the three-dimensional space. Exclusively changing the diameter d would not be sufficient for this effect because the user would only get the impression that the selected object 13 is a two-dimensional object that moves in a three-dimensional space. Other parameters can be considered for representing or simulating depth, such as the position of a virtual light source that influences shades, e.g. in the form of shape and color design, of the selected object.

A change of the Z value can adjust several design parameters of the selected object 13 in a 2.5D and 3D display. The magnitude of diameter d is one parameter. Other parameters may relate to the shape and the color design of the selected object. These can be determined by the changed virtual position of the selected object relative to the virtual light source.

A change of the Z value may further result in a change of associated functionality. For example, different functions may be assigned to the selected object 13 depending on the position of the input object 12 perpendicular to the plane 11. A function of the selected object 13 may, for example, be triggered when the plane 11 comes into contact with the input object 12. Alternatively, or in addition, an approximation of the input object 12 below a preset distance to the level 11 can trigger a function of the selected object 13. It is in principle conceivable that a function of the selected object 13 is triggered when the input object 12 approaches the plane 11 at a higher than the predetermined speed.

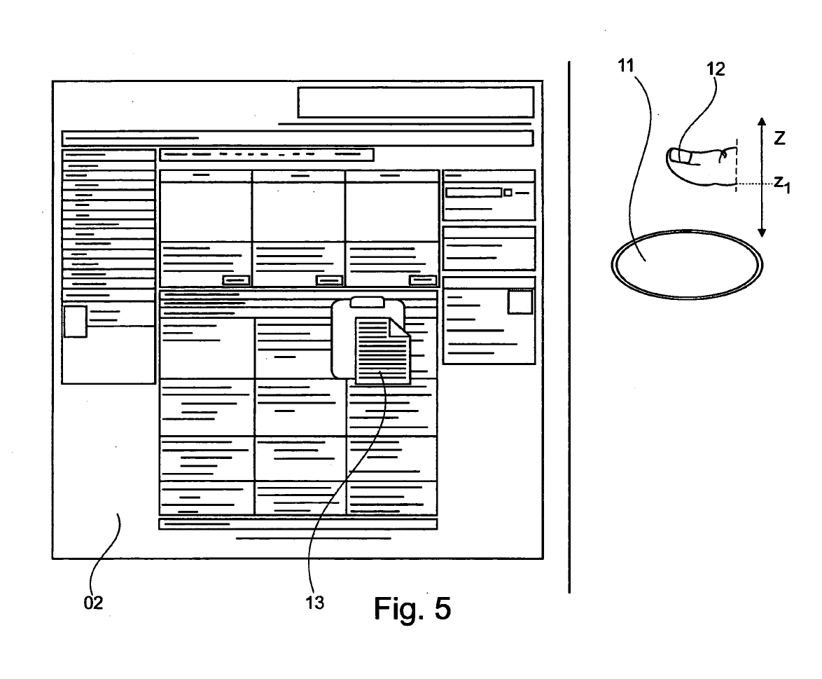

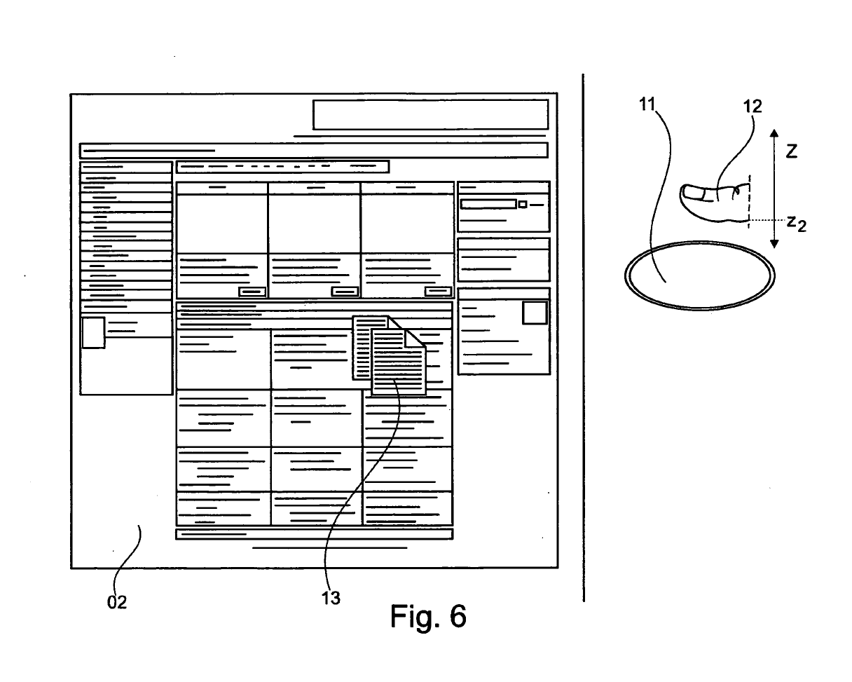

FIGS. 5 and 6 provide a diagrammatic view of the effect that a change of the Z value can have on the functionality of the selected object 13. The selected object 13 can be linked to a function. For example, a link to the file management commands Copy, Cut, and Paste may be useful for personal computers. When the Z value changes from z₁ to z₂, the functionality of the selected object 13 switches from Paste to Copy. The functionalities can then be activated, for example, by activating a key. Other activation options include detection of a gesture captured through the constellation of the positions of two or more input objects, or touching a defined spot or surface, for example, on plane 11. It is useful, for example, in the field of home electronics, to store a recording, playback, selection, zapping function or other functions with a function of the selected object 13 that depends on the Z value, and such function can then be selected by changing the Z value. In principle, all functions that the device to be processed offers are suitable for being triggered by a change of the Z value. A change of the Z value may also be used, for example, to locate a specific place in a video recording during a video playback. It is conceivable that, after invoking the function, a video file is unwound or rewound as a thumbnail or full image by changing the Z value. This can also be done for slide shows of still images. In music files, it is conceivable that a visualization like a progress bar can be used to go to a desired part of the musical piece or to a desired title in a play list by changing the Z value.

In the same way, a change of the Z value can be used for a preview function for documents and media of any kind. A range of values for Z is assigned to the preview function. When the input device enters this range, the document/media object is opened in a thumbnail view.

It should be pointed out that the invention can be used with any input system that is suitable for detecting a position of an object in a three-dimensional space as an alternative to its use with the described input device that facilitates the detection of the three-dimensional position of an input object 12 using a field of light-emitting diodes also called an array. This includes pressure-sensitive touch pads, optical systems with camera support, and any other system that is capable of identifying the three-dimensional position of an object based on an X, Y, and Z value. It is, for example, also conceivable that the input object itself is an input device that detects its three-dimensional position relative to a plane.

### CONCLUSION

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

What is claimed is:

1. A system comprising:
an input device configured to detect a three-dimensional position of an input object, wherein the three-dimensional position comprises a height position of the input object relative to a predetermined plane and a two-dimensional position parallel to the predetermined plane;
a processor coupled to the input device and configured to convert the three-dimensional position to a selected object for display on an output device, wherein the two-dimensional position determines coordinates for the selected object on the output device, and wherein the selected object is assigned one of a plurality of functions, and further wherein the object's function is dependent upon the height position; and
a trigger configured to activate the object's function when selected.

2. The system of claim 1, wherein the plurality of functions control a device.

3. The system of claim 1, wherein the plurality of functions control a software application.

4. The system of claim 1, wherein the trigger is a predetermined key on a keyboard, a predetermined location on the input device, or a predefined constellation of a first position of a first input object and a second position of a second input object.

5. The system of claim 1, wherein a color, a size, a shape, or a transparency of the selected object depends upon the height position.

6. The system of claim 1, wherein the input device detects the three-dimensional position of the input object using a pressure-sensitive touch pad or an array of light emitting diodes.

7. The system of claim 1, wherein the trigger is selected when the input object approaches the predetermined plane faster than a predetermined speed, comes closer than a predefined distance to the predetermined plane, or touches the predetermined plane.

8. A system comprising:
an input device configured to detect a three-dimensional position of an input object, wherein the three-dimensional position comprises a height position of the input object relative to a predetermined plane and a two-dimensional position parallel to the predetermined plane; and
a processor coupled to the input device and configured to convert the three-dimensional position to a selected position on an indicator for display on an output device, wherein the two-dimensional position determines coordinates for the selected object on the output device, and wherein the indicator is a visual representation of a file, and further wherein the selected position on the indicator corresponds to a file position in the file.

9. The system of claim 8, wherein the file is an audio, video, or text file.

10. The system of claim 8, wherein the file is a play list.

11. The system of claim 8, wherein the indicator is a bar, and the file maps to the bar such that a first end of the bar represents a beginning of the file, and a second end of the bar represents an end of the file.

12. The system of claim 8, wherein the input device detects the three-dimensional position of the input object using a pressure-sensitive touch pad or an array of light emitting diodes.

13. A system comprising:
an input device configured to detect a three-dimensional position of an input object, wherein the three-dimensional position comprises a height position of the input object relative to a predetermined plane and a two-dimensional position parallel to the predetermined plane; and
a processor coupled to the input device and configured to convert the three-dimensional position to a selected object for display on an output device, wherein the two-dimensional position determines coordinates for the selected object on the output device, and wherein the selected object is assigned a function when the height position is within a predetermined range.

14. The system of claim 13, wherein the function is a preview function for a document or a media file.

15. The system of claim 13, wherein the input device detects the three-dimensional position of the input object using a pressure-sensitive touch pad or an array of light emitting diodes.

16. A method comprising:
detecting a height position of an input object relative to a predetermined plane;
causing to be displayed an indicator on an output device, wherein the indicator is assigned one of a plurality of functions, and further wherein the object's function is dependent upon the height position; and
activating the object's function upon detection of a predetermined trigger.

17. The method of claim 16, wherein the plurality of functions control a device.

18. The method of claim 16, wherein the plurality of functions control a software application.

19. The method of claim 16, wherein the plurality of functions control a video, and further wherein a decrease in the height position is assigned a fast forward function, and an increase in the height position is assigned a rewind function.

20. The method of claim 16, wherein the plurality of functions control a text processing application, and further wherein the plurality of functions includes a copy function, a paste function, and a cut function.

21. The method of claim 16, wherein the predetermined trigger is a predetermined key on a keyboard, a predetermined gesture of two or more input objects, or a contact with a predetermined location.

22. A method comprising:
detecting a height position of an input object relative to a predetermined plane; and
causing to be displayed a selected position on an indicator on an output device, wherein the indicator is a visual representation of a file, and further wherein the selected position corresponds to a file position in the file.

23. The method of claim 22, wherein the file is an audio, video, or text file.

24. The method of claim 22, wherein the file is a play list.

25. The method of claim 22, wherein the indicator is a bar, and the file maps to the bar such that a first end of the bar represents a beginning of the file, and a second end of the bar represents an end of the file.

26. A method comprising:
detecting a height position of an input object relative to a predetermined plane; and
causing to be displayed an object on a selected output device, wherein the selected object is assigned a function when the height position is within a predetermined range.

27. The method of claim 26, wherein the function is a preview function for a document or a media file.
